(19) United States
(12) Patent Application Publication
(10) Pub. No.: US 2024/0414732 A1
(43) Pub. Date: Dec. 12, 2024

(54) TECHNIQUES FOR UPLINK TRANSMITTER FREQUENCY RESOURCE SWITCHING IN WIRELESS COMMUNICATIONS

(71) Applicant: QUALCOMM Incorporated, San Diego, CA (US)

(72) Inventors: Kazuki TAKEDA, Tokyo (JP); Peter GAAL, San Diego, CA (US); Mostafa KHOSHNEVISAN, San Diego, CA (US); Gokul SRIDHARAN, Sunnyvale, CA (US)

(21) Appl. No.: 18/330,832

(22) Filed: Jun. 7, 2023

(51) Int. Cl. H04W 72/232; H04W 72/0453

(52) U.S. Cl. CPC H04W 72/232; H04W 72/0453

(57) ABSTRACT

Aspects described herein relate to monitoring a control channel search space for downlink control information (DCI) based on at least two DCI formats associated with switching to one or more uplink frequency resources of multiple configured uplink frequency resources, decoding the DCI received in the control channel search space based on one of the at least two DCI formats and according to a size associated with the one of the at least two DCI formats, including decoding a field from the DCI, and switching to the one or more uplink frequency resources indicated in a frequency resource switching table based on the field. Other aspects relate to encoding and transmitting the DCI.

### FIELD OF THE DISCLOSURE

Aspects of the present disclosure relate generally to wireless communication systems, and more particularly, to techniques for switching uplink transmitter frequency resources.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect. 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to monitor a control channel search space for downlink control information (DCI) based on at least two DCI formats associated with switching to one or more uplink frequency resources of multiple configured uplink frequency resources, decode the DCI received in the control channel search space based on one of the at least two DCI formats and according to a size associated with the one of the at least two DCI formats, including decoding a field from the DCI, and switch to the one or more uplink frequency resources indicated in a frequency resource switching table based on the field.

In another aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to encode, for a user equipment (UE), DCI based on one of at least two DCI formats associated with switching to one or more uplink frequency resources of multiple configured uplink frequency resources, wherein the one or more processors are, individually or in combination, configured to execute the instructions to cause the apparatus to encode the DCI according to a size associated with the one of the at least two DCI formats, and includes encoding a field in the DCI, transmit the DCI in a control channel search space, and switch to one or more uplink frequency resources indicated in a frequency resource switching table based on the field for receiving uplink transmissions from the UE.

In another aspect, a method for wireless communication at a UE is provided that includes monitoring a control channel search space for DCI based on at least two DCI formats associated with switching to one or more uplink frequency resources of multiple configured uplink frequency resources, decoding the DCI received in the control channel search space based on one of the at least two DCI formats and according to a size associated with the one of the at least two DCI formats, including decoding a field from the DCI, and switching to the one or more uplink frequency resources indicated in a frequency resource switching table based on the field.

In another aspect, a method for wireless communication at a network node is provided that includes encoding, for a UE, DCI based on one of at least two DCI formats associated with switching to one or more uplink frequency resources of multiple configured uplink frequency resources, wherein encoding the DCI is according to a size associated with the one of the at least two DCI formats, and includes encoding a field in the DCI, transmitting the DCI in a control channel search space, and switching to one or more uplink frequency resources indicated in a frequency resource switching table based on the field for receiving uplink transmissions from the UE.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for decoding downlink control information (DCI) of at least one of multiple DCI formats associated with switching uplink frequency resources, in accordance with aspects described herein;

FIG. 6 is a flow chart illustrating an example of a method for encoding DCI of at least one of multiple DCI formats associated with switching uplink frequency resources, in accordance with aspects described herein;

FIG. 7 illustrates examples of DCI sizes of DCI for one or multiple frequency resources, in accordance with aspects described herein; and

FIG. 8 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to uplink transmitter frequency resource switching for a user equipment (UE). The UE can monitor for downlink control information (DCI), which can be of one of at least two different DCI formats defined for indicating the uplink transmitter frequency resource switching. The at least two different DCI formats can have different sizes that can correspond to DCI fields defined for a respective set of one or more transmitter frequency resources to which to switch. In one example, at least one of the different DCI formats can schedule switching the transmitter to concurrently use two different frequency resources for uplink transmissions. A transmitter frequency resource, as described herein, can include a component carrier (CC), a frequency band, a cell, etc., and as such the switching can include switching between CCs, switching between frequency bands, switching between cells, etc.

In fifth generation (5G) new radio (NR) or other wireless communication technologies for example, for a set of cells which are configured for multi-cell scheduling using a DCI format (such as one of the DCI formats 0_X for physical uplink shared channel (PUSCH) scheduling or one of the DCI formats 1_X for physical downlink shared channel (PDSCH) scheduling), the following functionality can be supported. If the UE is configured (e.g., by a network node via radio resource control (RRC) signaling) with a table defining combinations of co-scheduled cells for the set of cells, an indicator in the DCI can be included to point to one row of the table. Separate tables can be configured for downlink scheduling and uplink scheduling. The size of the indicator is equal to ceil (log 2(N)), where N is the number of rows in the table, and the maximum number of rows in the table may be 16. Currently in 5G NR, the size of fields for each co-scheduled cell does not change according to the indicated co-scheduled cell combination. In this regard, for example, the payload size of DCI format 1_X can be derived by UE based on RRC configuration of the active bandwidth part(s) (BWP(s)) of co-scheduled cell combinations within the set of cells, and the payload size of DCI format 1_X can be the same for the active BWP(s) of all the co-scheduled cell combinations and equal to the largest payload size among the active BWP(s) of all the co-scheduled cell combinations determined by the co-scheduled cell combination table. Similarly, in this example, the payload size of DCI format 0_X can be derived by UE based on RRC configuration of the active BWP(s) of co-scheduled cell combinations within the set of cells, and the payload size of DCI format 0_X can be the same for the active BWP(s) of all the co-scheduled cell combinations and equal to the largest payload size among the active BWP(s) of all the co-scheduled cell combinations determined by the co-scheduled cell combination table.

In addition, in 5G NR, uplink (UL) transmitter (Tx) switching can support switching to (or among) a single uplink carrier or dual uplink carriers. For “switchedUL” for UL-carrier aggregation (CA) and for single UL (SUL), the UE can transmit only on one frequency band at a time. For “dualUL” for UL-CA, the UE can transmit on up to two frequency bands at a time. In either example, in 5G NR, the number of Tx chains that can be used for simultaneous transmission is up to two. A time gap can also be defined for UL Tx switching (e.g., 35 microseconds (us), 140 us, or 210 us). For example, UL Tx switching can occur at most once per slot with a reference subcarrier switching (SCS). In an example, for UL-CA switchedUL and SUL, up to two Tx chains can be used for one of the available frequency bands (e.g., one of four frequency bands). In another example, for UL-CA dualUL, up to two Tx chains can be used for one of the available frequency bands or one Tx chain can be used for each of two of the available frequency bands in substantially any combination.

In 5G NR, for multi-carrier (MC)-scheduling in some examples, an indicator can be specified for parsing DCI, where dynamic parsing of DCI fields can be performed based on the cells that are co-scheduled by the DCI format. Depending on which/how many cells are co-scheduled by the DCI, the UE can interpret DCI fields in different ways, such as the DCI fields for the larger number of co-scheduled cells may be included with a possible compression, the DCI fields for smaller number of co-scheduled cells can use more bits for each DCI field, or when only one cell is scheduled by the MC-DCI, the MC-DCI can be treated as the legacy DCI format (e.g., in this case the MC-DCI can have a set of DCI fields that are supported in the legacy DCI format potentially without any field compression scheme).

Aspects described herein relate to using different DCI formats for switching transmitter frequency resources for a UE to use in transmitting uplink communications. The different DCI formats can be of different sizes based on one or more considerations of the transmitter frequency resource switching. For example, for dualUL, different DCI formats having different DCI format sizes can be used to indicate whether transmitter frequency resource switching is for a single frequency resource (e.g., for both Tx chains) or two frequency resources (e.g., one for each Tx chain). In addition, the DCI format can include an indicator (e.g., the indicator specified for dynamic DCI parsing) to indicate the Tx chain configuration for the frequency resource switching. In another example, for dualUL, different DCI formats having different DCI format sizes can be used to indicate certain Tx chains to be used in the transmitter frequency resource switching.

In accordance with aspects described herein, using different DCI formats and format sizes for different configurations of transmitter frequency resource switching can allow for more efficient communication and processing of DCI. For example, certain frequency resources may have additional or larger DCI fields, which can require more bits for transmitting the DCI. In this regard, based on the indicator indicating the Tx chain configuration, the network node can transmit, and/or the UE can process, the DCI based on a DCI format size that algins with the required size for frequency resources (or a number of frequency resources per Tx chain) indicated by the indicator. This can improve radio spectrum usage, and thus performance, power consumption, etc. of wireless communication devices. This can also improve user experience when using the UE.

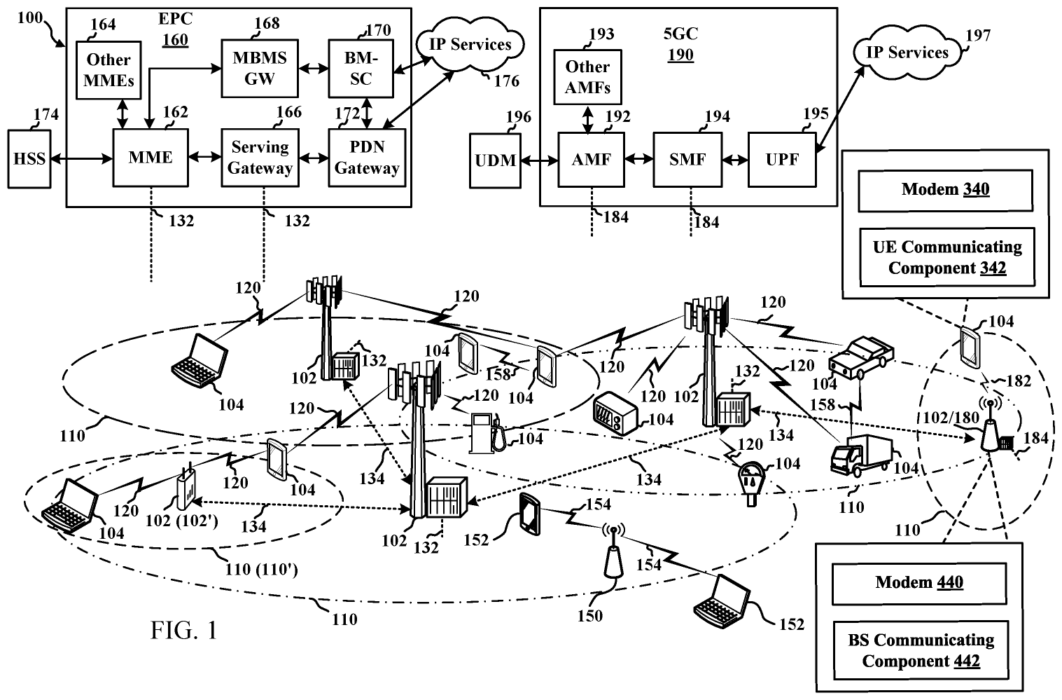

The described features will be presented in more detail below with reference to FIGS. 1-8.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X. Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X. Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X. and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, ctc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for decoding a DCI of at least one of multiple DCI formats associated with switching uplink frequency resources, in accordance with aspects described herein. In addition, some nodes may have a modem 440 and BS communicating component 442 for encoding a DCI of at least one of multiple DCI formats associated with switching uplink frequency resources, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an SI interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHZ and a wavelength between 1 millimeter and 10 millimeters. Radio waves in the band may be referred to as a millimeter wave. Near mmW may extend down to a frequency of 3 GHZ with a wavelength of 100 millimeters. The super high frequency (SHF) band extends between 3 GHZ and 30 GHZ, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (CNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), cFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, BS communicating component 442 can encode, for a UE 104, DCI for switching uplink frequency resources, where the DCI is of one of multiple DCI formats defined for switching uplink frequency resources. In an example, UE communicating component 342 can monitor a control channel search space for the DCI, and can decode the DCI based on one of the multiple DCI formats, where each DCI format may have a different DCI format size that may be based on the uplink frequency resources for switching. For example, the DCI format size can be based on whether the uplink frequency resources include one or multiple frequency resource for switching multiple Tx chains or multiple frequency resources for switching each of multiple Tx chains to different frequency resources. In another example, the DCI format size can be based on which frequency resources, of multiple possible frequency resources, are indicated in the DCI for switching.

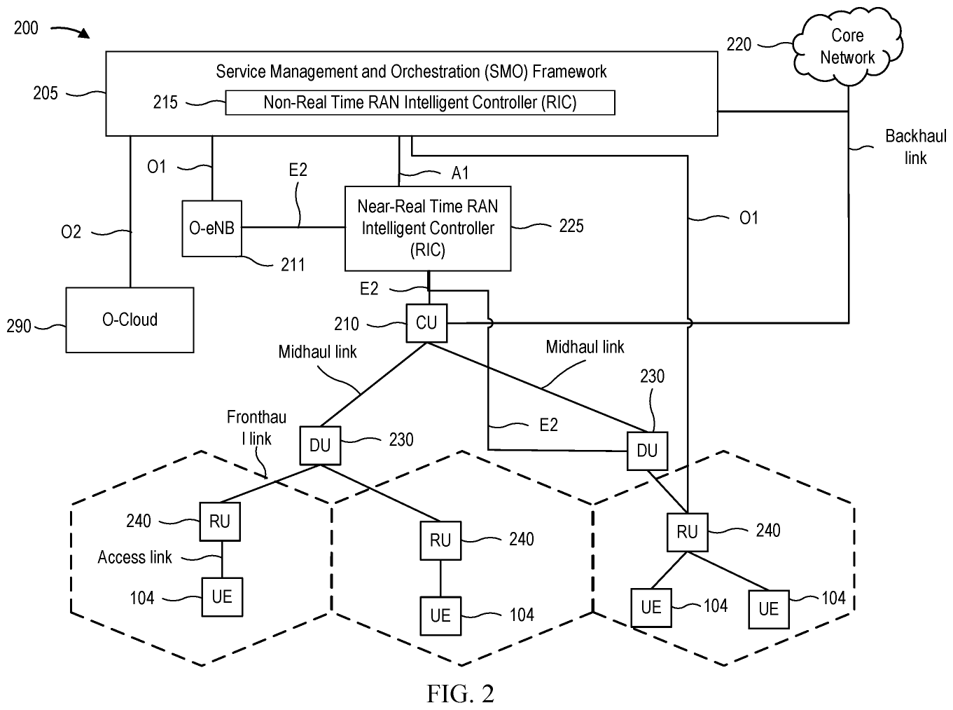

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-cNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

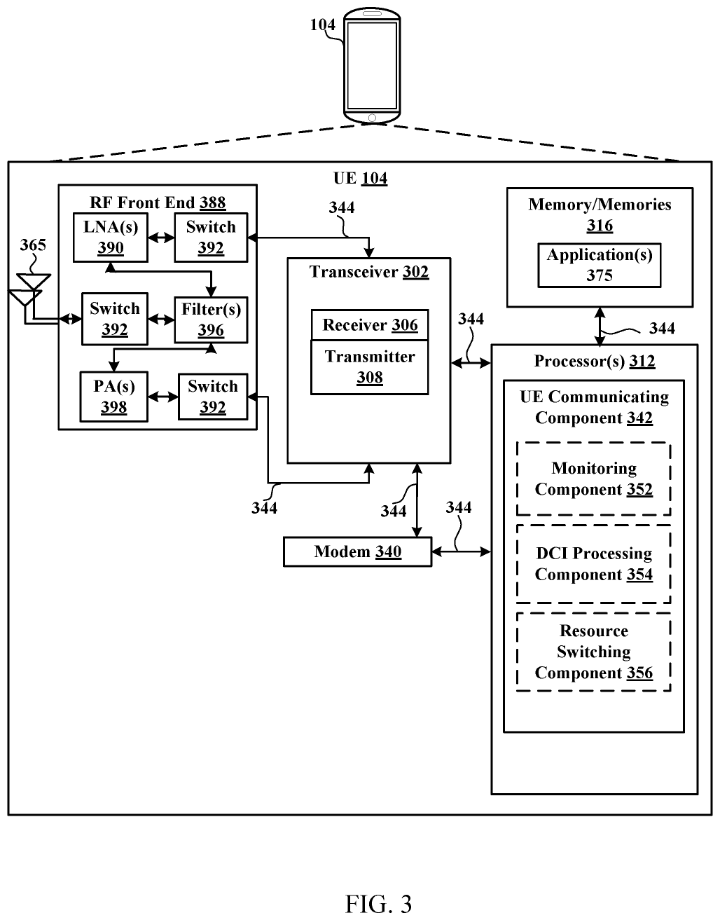

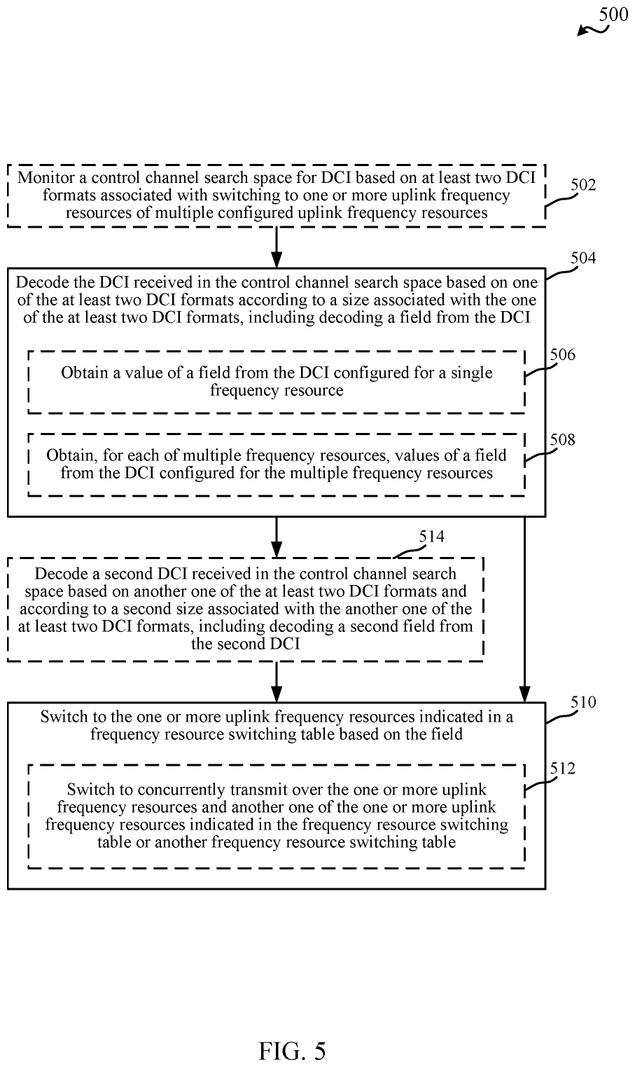

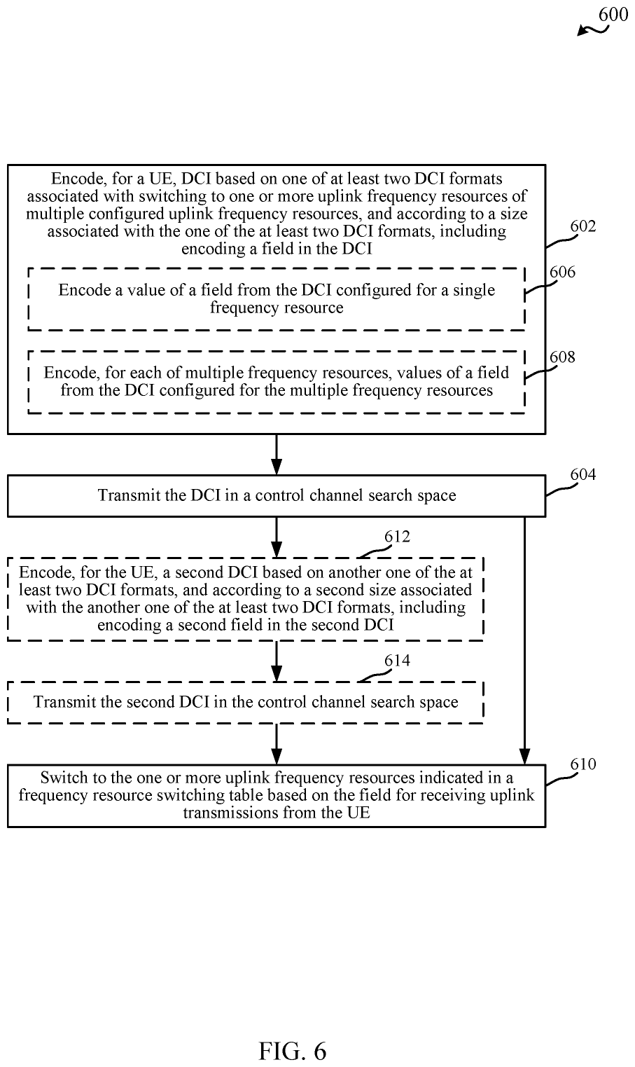

Turning now to FIGS. 3-8, aspects are depicted with reference to one or more components and one or more methods that may perform the actions or operations described herein, where aspects in dashed line may be optional. Although the operations described below in FIGS. 5-6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for decoding a DCI of at least one of multiple DCI formats associated with switching uplink frequency resources, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312. Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE 104 can also include a monitoring component 352 for monitoring a control channel search space for DCI related to uplink frequency resource switching, a DCI processing component 354 for decoding or otherwise processing the DCI, and/or a resource switching component 356 for switching uplink frequency resources based on the DCI.

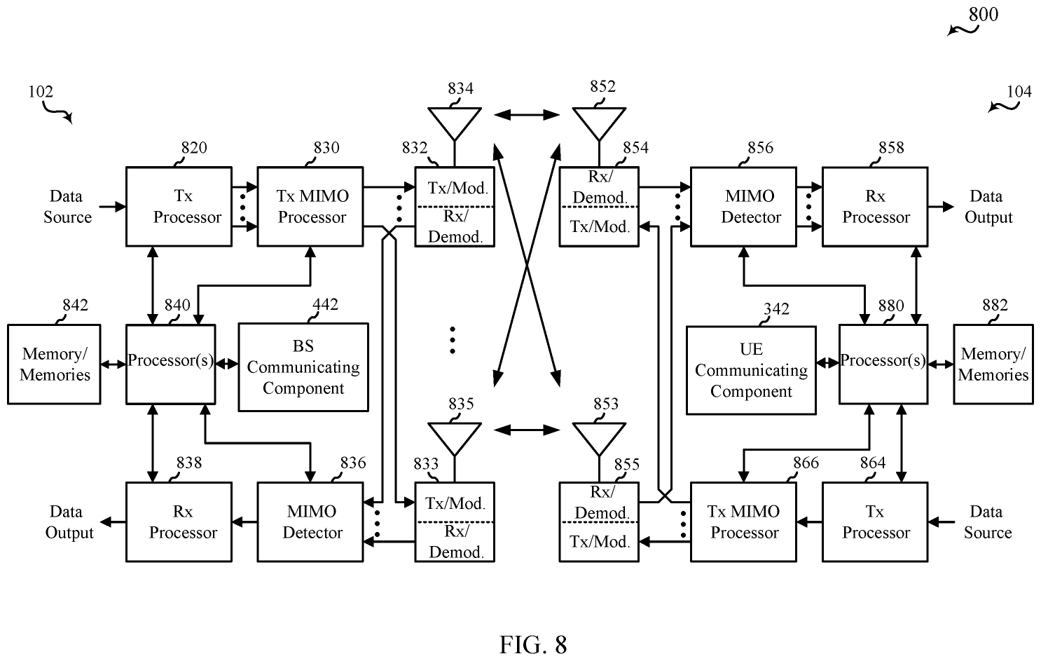

In an aspect, the processor(s) 312 may correspond to one or more of the processors described in connection with the UE in FIG. 8. Similarly, the memory/memories 316 may correspond to the memory/memories described in connection with the UE in FIG. 8.

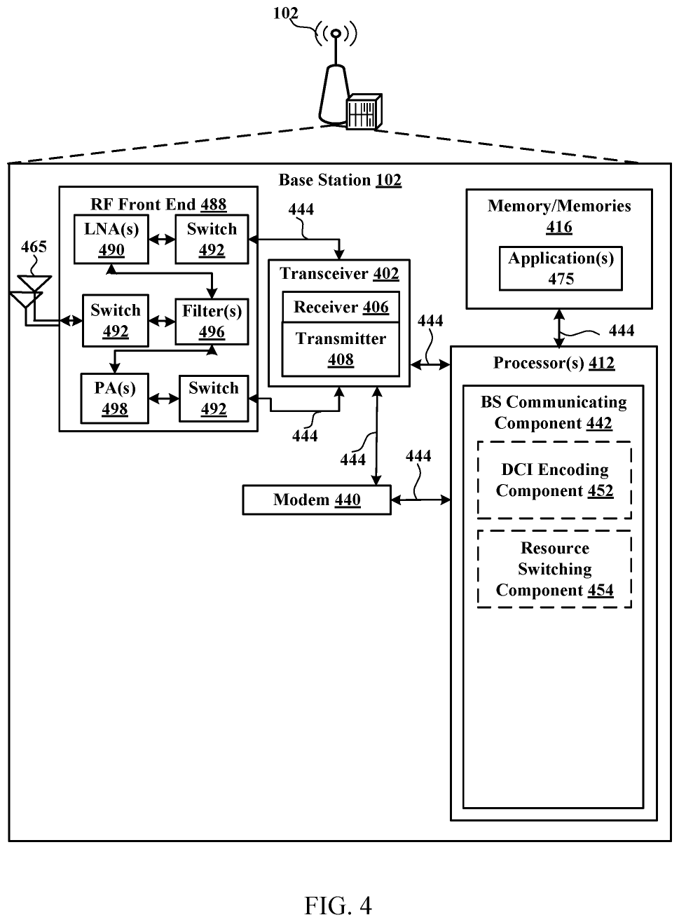

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444, which may operate in conjunction with modem 440 and BS communicating component 442 for encoding a DCI of at least one of multiple DCI formats associated with switching uplink frequency resources, in accordance with aspects described herein.

The one or more transceivers 402, receiver 406, transmitter 408, one or more processors 412, one or more memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a DCI encoding component 452 for encoding DCI for a UE related to uplink frequency resource switching, and/or a resource switching component 454 for switching uplink frequency resources for receiving uplink communications from the UE based on the DCI.

In an aspect, the processor(s) 412 may correspond to one or more of the processors described in connection with the base station in FIG. 8. Similarly, the memory/memories 416 may correspond to the memory/memories described in connection with the base station in FIG. 8.

FIG. 5 illustrates a flow chart of an example of a method 500 for decoding DCI of at least one of multiple DCI formats associated with switching uplink frequency resources, in accordance with aspects described herein. FIG. 6 illustrates a flow chart of an example of a method 600 for encoding DCI of at least one of multiple DCI formats associated with switching uplink frequency resources, in accordance with aspects described herein. In an example, a UE 104 or other device (e.g., an IoT device, EH device, etc.) can perform the functions described in method 500 shown in FIG. 5 using one or more of the components described in FIGS. 1 and 3. In an example, a network node (e.g., a base station 102 or gNB 180, a monolithic base station or gNB, a portion of a disaggregated base station or gNB, etc.), a UE 104 in sidelink communications, etc. can perform the functions described in method 600 shown in FIG. 6 using one or more of the components described in FIGS. 1 and 4. Methods 500 and 600 are described in conjunction with one another for ease of explanation; however, the methods 500 and 600 are not required to be performed together and indeed can be performed independently using separate devices.

In method 600, at Block 602, DCI for a UE can be encoded based on one of at least two DCI formats associated with switching to one or more uplink frequency resources of multiple configured uplink frequency resources, an according to a size associated with the one of the at least two DCI formats, including encoding a field in the DCI. In an aspect, DCI encoding component 452, e.g., in conjunction with processor(s) 412, memory/memories 416, transceiver 402, BS communicating component 442, etc., can encode, for the UE (e.g., UE 104), DCI based on one of at least two DCI formats associated with switching to one or more uplink frequency resources of multiple configured uplink frequency resources, and according to the size associated with the one of the at least two DCI formats, including encoding a field in the DCI. For example, the DCI formats can be of DCI format sizes that are associated with the uplink frequency resources to which the UE 104 is to switch one or more Tx chains.

In one example, the DCI formats can include a first DCI format having a first size and associated with switching to a single uplink frequency resource of the multiple configured uplink frequency resources, or a second DCI format having a second size, larger than the first size, and associated with switching to concurrently transmit over two uplink frequency resources of the multiple configured uplink frequency resources. In another example, the DCI formats can include a first DCI format having a first size and associated with switching to at least one of the multiple configured uplink frequency resources, or a second DCI format having a second size, larger than the first size, and associated with switching to at least another one of the multiple configured uplink frequency resources. For example, the first size can include a size for communicating DCI information fields for the single uplink frequency resource, and the second size can include a sum of sizes for transmitting DCI information fields for each of the multiple uplink frequency resources (or may include sizes for some common information fields for the multiple uplink frequency resources). In an example, DCI encoding component 452 can select the DCI format to use and include information in associated DCI fields based on the one or more uplink frequency resources to which the UE 104 is to switch.

In one example, the field encoded in the DCI (e.g., at least one of the fields) can include an indicator of which frequency resource(s) are to be associated with which Tx chains. For example, the indicator can be an index into a frequency resource switching table, as described further herein, where the index can be associated with a row that indicates, for each frequency resource, how many frequency resources (e.g., CCs, cells, frequency bandwidths, etc.) are to be associated with one or more Tx chains at the UE 104.

In method 600, at Block 604, the DCI can be transmitted in a control channel search space. In an aspect, BS communicating component 442, e.g., in conjunction with processor(s) 412, memory/memories 416, transceiver 402, etc., can transmit the DCI in the control channel search space. For example, BS communicating component 442 can transmit the DCI in a search space that is specific for the UE or common for multiple UEs. BS communicating component 442 can transmit the DCI in a PDCCH, PDSCH, etc., which can be received by the UE 104 in the search space.

In method 500, optionally at Block 502, a control channel search space can be monitored for DCI based on at least two DCI formats associated with switching to one or more uplink frequency resources of multiple configured uplink frequency resources. In an aspect, monitoring component 352, e.g., in conjunction with processor(s) 312, memory/memories 316, transceiver 302, UE communicating component 342, etc., can monitor a control channel search space for DCI based on at least two DCI formats associated with switching to one or more uplink frequency resources of multiple configured uplink frequency resources. For example, monitoring component 352 can monitor a common search space or a UE-specific search space specific for UE 104 for the DCI. In an example, monitoring component 352 can perform blind decoding of the search space to decode the control channel that includes the DCI. As described, for example, the DCI formats can be of DCI format sizes that are associated with the uplink frequency resources to which the UE 104 is to switch one or more Tx chains. For example, the Tx chains can include a portion of the transceiver 302, one or more transceivers 302, one or more RF components (e.g., in RF front end 388), and/or the like, to allow the UE 104 to concurrently transmit uplink communications over one or more sets of uplink frequency resources.

As described, for example, the UE 104 can have two (or more) Tx chains to transmit uplink communications over associated resources (e.g., CCs, cells, frequency bands, etc.). As such, a network node can configure the UE with uplink frequency resources for the two (or more) Tx chains, including a single frequency resource (e.g., CC, cell, frequency band, etc.) for the two (or more) Tx chains, a different frequency resource (e.g., CC, cell, frequency band, etc.) for each of the two (or more) Tx chains, and/or the like. For example, for uplink resource switching in 5G NR, the UE can be configured with a frequency resource switching table (e.g., in RRC signaling or other configuration), which can include rows indicating which Tx chains (or a number of Tx chains) to allocate to each of multiple uplink frequency resources. For example, the frequency resource switching table may have a format similar to the following:

UL-CA “dualUL”
2T, 0T, 0T, 0T
0T, 2T, 0T, 0T
0T, 0T, 2T, 0T
0T, 0T, 0T, 2T
1T, 1T, 0T, 0T
1T, 0T, 1T, 0T
1T, 0T, 0T, 1T
0T, 1T, 1T, 0T
0T, 1T, 0T, 1T
0T, 0T, 1T, 1T

where each element in a row indicates a Tx chain of the UE, 2T indicates two frequency resources assigned to the associated Tx chain, 1T indicates one frequency resource assigned to the associated Tx chain, and 0T indicates zero frequency resources assigned to the associated Tx chain. In this example, the first four rows of the frequency resource switching table indicate two frequency resources assigned to one Tx chain, and the remaining rows indicate one frequency resource assigned to each of two Tx chains (e.g., for multi-cell or multi-CC transmission).

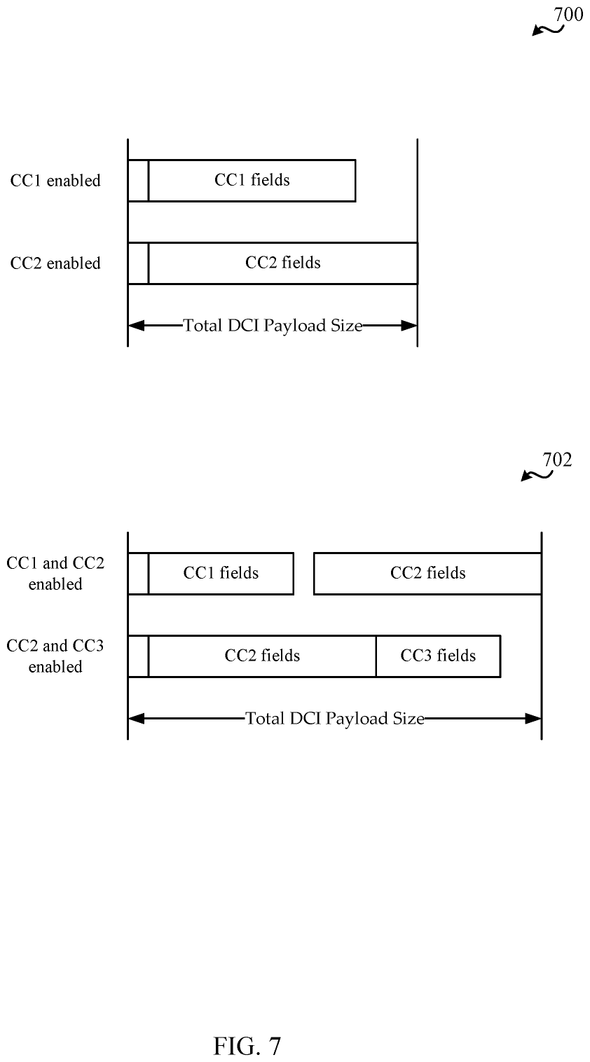

As described, based on whether multiple frequency resources are assigned to one Tx chain or one frequency resource is assigned to each of multiple Tx chains, the information fields for the DCI can be different or of different sizes. As such, aspects described herein can facilitate encoding/decoding DCI of a size that is closer to the actual size of the information fields, in some examples. An example is shown in FIG. 7.

FIG. 7 illustrates examples of DCI sizes of DCI for one or multiple frequency resources (e.g., one or multiple CCS, cells, or frequency bands). For example, DCI format sizes 700 are shown for a first CC (CC1) and a second CC (CC2), and can be different based on fields or information for the respective CCs. In an example, however, the total number of bits of the DCI format can remain fixed and unchanged. For example, in FIG. 700, both CC1-enabled and CC2-enabled can have the same total size, but the number of useful bits in the corresponding DCI format can be different. In addition, for example, DCI format sizes 702 are shown for configuring two CCs (e.g., CC1 and CC2 or CC2 and a third CC (CC3), etc.), and can also be different based on fields or information for configuring the set of CCs. As shown, the maximum DCI size for a single CC (e.g., in DCI format sizes 700) can be less than the maximum sum of DCI size for two CCs (e.g., in DCI format sizes 702). As such, for example, using different DCI formats for single CC and two CCs can allow for improved resource usage by facilitating encoding or decoding based on maximum DCI format sizes more closely aligned to the DCI being encoded/decoded. In another example, the DCI format and/or DCI format sizes can be different based on which CC(s) is/are being configured for the Tx chains. For example, CCs having DCI information resulting in larger sizes can be configured using a different DCI and/or associated format sizes than CCs having DCI information resulting in smaller sizes.

In a specific example, a network node can use MC-scheduling as defined in 5G NR for search space (SS) set configuration and blind decoding (BD) size limit, control channel element (CCE) size limit, and/or DCI size limit, in transmitting DCI, in accordance with aspects described herein. For example, monitoring component 352 can monitor a SS set configured on the scheduling cell, which can have linked SS set (SSID) on one or each scheduled cell. If the monitoring component 352 monitors the DCI(s) with a frequency resource switching indicator, as described further in examples herein, the BD/CCE/DCI-size for monitoring the PDCCH for the DCI(s) can be counted on a reference cell, where the reference cell is the scheduling cell if the scheduling cell is part of the cells for UL-Tx switching, and/or the reference cell is one of the scheduled cells (which is configured by a parameter from the network node) if the scheduling cell is not part of the cells for UL-Tx switching. For the case where the monitoring component 352 monitors two DCI payloads (e.g., for dualUL), either (1) BD/CCE/DCI-size for PDCCH for both DCI payloads are counted on the same reference cell, or (2) BD/CCE/DCI-size for PDCCH for each DCI payload are counted on each corresponding reference cell. In addition, in some examples, monitoring component 352 can monitor both MC-DCI and SC-DCI for each cell, as MC-DCI can have a large payload and may have coarser scheduling granularity (e.g., large RBG size for FDRA), as described herein.

In method 500, at Block 504, the DCI received in the control channel search space can be decoded based on one of the at least two DCI formats according to a size associated with the one of the at least two DCI formats, including decoding a field from the DCI. In an aspect, DCI processing component 354, e.g., in conjunction with processor(s) 312, memory/memories 316, transceiver 302, UE communicating component 342, etc., can decode the DCI received in the control channel search space based on one of the at least two DCI formats according to a size associated with the one of the at least two DCI formats, including decoding a field from the DCI. For example, monitoring component 352 can perform blind decoding based on the at least two DCI formats or associated DCI format sizes such to allow the network node to select a size that is appropriate for the DCI being transmitted. In one example, as described, the at least two DCI format sizes can relate to whether the DCI includes fields for one frequency resource (e.g., where one frequency resource is assigned to one or multiple Tx chains) or DCI fields for multiple frequency resources (e.g., where at least one frequency resource is assigned to each of multiple Tx chains). In another example, the at least two DCI format sizes can relate to one or a subset of the frequency resources that are being assigned to one or more Tx chains. In any case, DCI processing component 354 can blindly decode the DCI and can determine a frequency resource to Tx chain(s) mapping based at least in part on the DCI format size.

In an example, DCI processing component 354 can additionally decode at least one field that can include an indicator of which Tx chains are to use a number of frequency resources. For example, as described, the field can include an index into a frequency resource switching table configured for the UE 104. Thus, for example, based on blindly decoding the DCI format, determining the associated DCI format size, and/or the field that indicates the index into the frequency resource switching table, DCI processing component 354 can determine Tx chains to use to communicate over one or more frequency resources and the DCI fields associated with each of the one or more frequency resources (e.g., CC(s), cell(s), frequency band(s), etc.). For example, in the UL-CA dualUL table above, the DCI can be of a first format and/or size for the first four rows of the table where one frequency resource is assigned to two Tx chains or a second format and/or size for the remaining rows of the table where each of two frequency resources is assigned to a different Tx chain. In this example, the DCI of the first format can include fields for the one frequency resource, and the DCI of the second format can include fields for the two frequency resources.

Thus, in one example, in encoding the DCI at Block 602, optionally at Block 606, a value of a field from the DCI configured for a single frequency resource can be encoded. In an aspect. DCI encoding component 452, e.g., in conjunction with processor(s) 412, memory/memories 416, transceiver 402, BS communicating component 442, etc., can encode the value of the field from the DCI configured for the single frequency resource. For example, DCI encoding component 452 can encode multiple fields into the DCI that relate to the single frequency resource (e.g., as shown in DCI format sizes 700 in FIG. 7), such as a frequency domain resource allocation (FDRA), time domain resource allocation (TDRA), feedback indicator or resources, etc., where the DCI relates to the single frequency resource for switching one or more Tx chains to use.

In another example, in encoding the DCI at Block 602, optionally at Block 608, for each of multiple frequency resources, values of a field from the DCI configured for the multiple frequency resource can be encoded. In an aspect, DCI encoding component 452, e.g., in conjunction with processor(s) 412, memory/memories 416, transceiver 402, BS communicating component 442, etc., can encode, for each of multiple frequency resources, values of the field from the DCI configured for the multiple frequency resource. For example, DCI encoding component 452 can encode multiple fields into the DCI that relate to each of the multiple frequency resources (e.g., as shown in DCI format sizes 702 in FIG. 7), such as a FDRA, TDRA, feedback indicator or resources, etc., where the DCI relates to the multiple frequency resource for switching each of multiple Tx chains to use. One or more of the fields, size of fields, information in the fields, etc. can be different for each of the multiple frequency resources, in some examples.

In an example, in decoding the DCI at Block 504, optionally at Block 506, a value of a field from the DCI configured for a single frequency resource can be obtained. In an aspect, DCI processing component 354, e.g., in conjunction with processor(s) 312, memory/memories 316, transceiver 302, UE communicating component 342, etc., can obtain the value of the field from the DCI configured for the single frequency resource. For example, DCI processing component 354 can obtain multiple fields from the DCI that relate to the single frequency resource (e.g., as shown in DCI format sizes 700 in FIG. 7), such as a FDRA, TDRA, feedback indicator or resources, etc., where the DCI relates to the single frequency resource for switching one or more Tx chains to use.

In an example, in decoding the DCI at Block 504, optionally at Block 508, for each of multiple frequency resources, values of a field from the DCI configured for the multiple frequency resource can be obtained. In an aspect, DCI processing component 354, e.g., in conjunction with processor(s) 312, memory/memories 316, transceiver 302, UE communicating component 342, etc., can obtain, for each of the multiple frequency resources, values of the field from the DCI configured for the multiple frequency resources. For example, DCI processing component 354 can obtain multiple fields from the DCI that relate to each of the multiple frequency resources (e.g., as shown in DCI format sizes 702 in FIG. 7), such as a FDRA, TDRA, feedback indicator or resources, etc., where the DCI relates to the multiple frequency resource for switching each of multiple Tx chains to use. One or more of the fields, size of fields, information in the fields, etc. can be different for each of the multiple frequency resources, in some examples.

In method 500, at Block 510, the one or more uplink frequency resources indicated in a frequency resource switching table can be switched to based on the field. In an aspect, resource switching component 356, e.g., in conjunction with processor(s) 312, memory/memories 316, transceiver 302, UE communicating component 342, etc., can switch to the one or more uplink frequency resources indicated in the frequency resource switching table based on the field. For example, as described, the UE 104 can be configured with the frequency resource switching table, and the field decoded from the DCI can indicate a row in the table corresponding to a configuration of a number of Tx chains for each of multiple possible frequency resources that may be configured. For example, resource switching component 356 can use the information decoded from the DCI fields for one or more frequency resources, depending on the DCI format decoded, and accordingly switch multiple Tx chains to use the one or more frequency resources based at least in part on the information in the DCI fields (e.g., the FDRA or TDRA for each frequency resource, the feedback indicators or resources for each frequency resource, etc.).

In one example, in switching to the one or more uplink frequency resources at Block 510, optionally at Block 512, the one or more uplink frequency resources and another one of the one or more uplink frequency resources indicated in the frequency resource switching table of another frequency resource switching table can be switched to to concurrently transmit over the frequency resources. In an aspect, resource switching component 356, e.g., in conjunction with processor(s) 312, memory/memories 316, transceiver 302, UE communicating component 342, etc., can switch to concurrently transmit over the one or more uplink frequency resources and another one of the one or more uplink frequency resources indicated in the frequency resource switching table or another frequency resource switching table. Thus, as described for example, resource switching component 356 can switch one Tx chain to use one frequency resource and another Tx chain to use another frequency resource for concurrent communications where the frequency resource switching table indicates to assign different frequency resources to two different Tx chains. In this example, resource switching component 356 can configure each frequency resource based on the corresponding fields decoded from the DCI (e.g., for MC-DCI).

In method 600, at Block 610, the one or more uplink frequency resources indicated in a frequency resource switching table based on the field can be switched to for receiving uplink transmissions from the UE. In an aspect, resource switching component 454, e.g., in conjunction with processor(s) 412, memory/memories 416, transceiver 402, BS communicating component 442, etc., can switch to the one or more uplink frequency resources indicated in the frequency resource switching table, based on the field, for receiving the uplink transmission from the UE. Resource switching component 454 can switch to the one or more uplink frequency resources as assigned for the UE 104, as described above, in the encoded DCI such to receive uplink communications using the corresponding parameters (e.g., over a configured FDRA or TDRA, etc.).

In another example, as described, the DCI format and/or size can relate to (e.g., indicate or be used to determine) which frequency resource(s) are being assigned for use by the multiple Tx chains. For example, the DCI format size can be of one size for certain frequency resources and another size for other frequency resources. The following table shows an example of DCI format sizes where 2T or 1T in parentheses indicates a first DCI format size, and 2T or 1T not in parentheses indicates a second DCI format size:

UL-CA “dualUL”

(2T), 0T, 0T, 0T
0T, (2T), 0T, 0T
0T, 0T, 2T, 0T
0T, 0T, 0T, 2T
(1T), 1T, 0T, 0T
(1T), 0T, 1T, 0T
(1T), 0T, 0T, 1T
0T, (1T), 1T, 0T
0T, (1T), 0T, 1T
0T, 0T, (1T), 1T

In this example, multiple DCIs payload can be included in the DCI, where each payload can include an indicator indicating frequency resource switching and each can trigger transmission on one frequency resource (e.g., CC, cell, frequency band, etc.) for a given frequency resource switching case. In this example, as each DCI size (whether in parentheses or not) does not schedule more than one CC in any row, the DCI payload size can be smaller than a DCI size that is for multi-CC scheduling.

In this example, if the two DCI payload sizes are different, the UE can identify the detected DCI payload based on blind decodes with the different DCI payload size hypotheses, as described above. If the two DCI payload sizes are same, other mechanisms can be used to distinguish the two DCI payloads for different UL transmissions—e.g., separate sets of PDCCH candidates, an explicit field in the DCI payload indicating which of the DCI payload it is, etc.

In this example, in method 600, optionally at Block 612, a second DCI can be encoded for the UE based on another one of the at least two DCI formats, and according to a second size associated with the another one of the at least two DCI formats, including encoding a second field in the second DCI. In an aspect, DCI encoding component 452, e.g., in conjunction with processor(s) 412, memory/memories 416, transceiver 402, BS communicating component 442, etc., can encode, for the UE, the second DCI based on another one of the at least two DCI formats, and according to the second size associated with another one of the at least two DCI formats, including encoding the second field in the second DCI. For example, the second field can be the indicator for the uplink frequency switching for the second DCI, as described. In addition, the second DCI can include various fields related to the second frequency resource. DCI encoding component 452 can encode the first DCI according to a maximum size for the frequency resources that can be possibly encoded as the first DCI and can encode the second DCI according to a maximum size for the frequency resources that can be possibly encoded as the second DCI.

In method 600, optionally at Block 614, the second DCI can be transmitted in the control channel search space. In an aspect, BS communicating component 442, e.g., in conjunction with processor(s) 412, memory/memories 416, transceiver 402, etc., can transmit the second DCI in the control channel search space, along with the first DCI (e.g., as one DCI having two DCI payloads or otherwise). For example, BS communicating component 442 can transmit the second DCI in the search space that is specific for the UE or common for multiple UEs. BS communicating component 442 can transmit the second DCI in the PDCCH, PDSCH, etc., which can be received by the UE 104 in the search space.

In method 500, optionally at Block 514, the second DCI received in the control channel search space can be decoded based on another one of the at least two DCI formats according to a second size associated with the another one of the at least two DCI formats, including decoding a second field from the DCI. In an aspect, DCI processing component 354, e.g., in conjunction with processor(s) 312, memory/memories 316, transceiver 302, UE communicating component 342, etc., can decode the second DCI received in the control channel search space based on another one of the at least two DCI formats according to a size associated with the one of the at least two DCI formats, including decoding a field from the DCI. For example, monitoring component 352 can perform blind decoding over the control channel search space based on the at least two DCI formats or associated DCI format sizes such to allow the network node to select a size that is appropriate for the DCIs being transmitted. In one example, as described, the at least two DCI format sizes can relate to the frequency resource being assigned. In any case, DCI processing component 354 can blindly decode both of the DCI and the second DCI and can determine a frequency resource to Tx chain(s) mapping based at least in part on the DCI format size of the DCI and/or the second DCI format size of the second DCI, and/or based on the field of the DCI and/or on the second field of the second DCI, which may include the indicator in the frequency resource switching table indicating which frequency resource(s) is/are being assigned, as described above.

As described in reference to Block 512, resource switching component 356 can accordingly switch to concurrently use the frequency resources for the respective Tx chains based on determining the DCI format size of the DCI, the second DCI format size of the second DCI, the field of the DCI, and/or the second field of the second DCI in the first and/or second DCIs, along with additional fields from the first and/or second DCI indicating DCI information such as FDRA, TDRA, etc. Similarly, for example as described in reference to Block 610, resource switching component 454 can also switch to use the frequency resources, as assigned by the first and second DCIs, for receiving uplink transmissions from the UE 104.

FIG. 8 is a block diagram of a MIMO communication system 800 including a base station 102 and a UE 104. The MIMO communication system 800 may illustrate aspects of the wireless communication access network 100 described with reference to FIG. 1. The base station 102 may be an example of aspects of the base station 102 described with reference to FIG. 1. The base station 102 may be equipped with antennas 834 and 835, and the UE 104 may be equipped with antennas 852 and 853. In the MIMO communication system 800, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor(s) 820 may receive data from a data source. The transmit processor(s) 820 may process the data. The transmit processor(s) 820 may also generate control symbols or reference symbols. A transmit MIMO processor(s) 830 may perform spatial processing (e.g., precoding) on data symbols, control symbols, or reference symbols, if applicable, and may provide output symbol streams to the transmit modulator/demodulators 832 and 833. Each modulator/demodulator 832 through 833 may process a respective output symbol stream (e.g., for OFDM, etc.) to obtain an output sample stream. Each modulator/demodulator 832 through 833 may further process (e.g., convert to analog, amplify, filter, and upconvert) the output sample stream to obtain a DL signal. In one example, DL signals from modulator/demodulators 832 and 833 may be transmitted via the antennas 834 and 835, respectively.

The UE 104 may be an example of aspects of the UEs 104 described with reference to FIGS. 1 and 3. At the UE 104, the UE antennas 852 and 853 may receive the DL signals from the base station 102 and may provide the received signals to the modulator/demodulators 854 and 855, respectively. Each modulator/demodulator 854 through 855 may condition (e.g., filter, amplify, downconvert, and digitize) a respective received signal to obtain input samples. Each modulator/demodulator 854 through 855 may further process the input samples (e.g., for OFDM, etc.) to obtain received symbols. A MIMO detector 856 may obtain received symbols from the modulator/demodulators 854 and 855, perform MIMO detection on the received symbols, if applicable, and provide detected symbols. A receive (Rx) processor(s) 858 may process (e.g., demodulate, deinterleave, and decode) the detected symbols, providing decoded data for the UE 104 to a data output, and provide decoded control information to a processor(s) 880, or memory/memories 882.

The processor(s) 880 may in some cases execute stored instructions to instantiate a UE communicating component 342 (see e.g., FIGS. 1 and 3).

On the uplink (UL), at the UE 104, a transmit processor(s) 864 may receive and process data from a data source. The transmit processor(s) 864 may also generate reference symbols for a reference signal. The symbols from the transmit processor(s) 864 may be precoded by a transmit MIMO processor(s) 866 if applicable, further processed by the modulator/demodulators 854 and 855 (e.g., for single carrier-FDMA, etc.), and be transmitted to the base station 102 in accordance with the communication parameters received from the base station 102. At the base station 102, the UL signals from the UE 104 may be received by the antennas 834 and 835, processed by the modulator/demodulators 832 and 833, detected by a MIMO detector 836 if applicable, and further processed by a receive processor(s) 838. The receive processor(s) 838 may provide decoded data to a data output and to the processor(s) 840 or memory/memories 842.

The processor(s) 840 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 800. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 800.

The following aspects are illustrative only and aspects thereof may be combined with aspects of other embodiments or teaching described herein, without limitation.
Aspect 1 is a method for wireless communication at a UE including monitoring a control channel search space for DCI based on at least two DCI formats associated with switching to one or more uplink frequency resources of multiple configured uplink frequency resources, decoding the DCI received in the control channel search space based on one of the at least two DCI formats and according to a size associated with the one of the at least two DCI formats, including decoding a field from the DCI, and switching to the one or more uplink frequency resources indicated in a frequency resource switching table based on the field.
In Aspect 2, the method of Aspect 1 includes where the at least two DCI formats include a first DCI format having a first size and associated with switching to a single frequency resource of the multiple configured uplink frequency resources, and a second DCI format having a second size, larger than the first size, and associated with switching to concurrently transmit over two uplink frequency resources of the multiple configured uplink frequency resources, where the DCI is of the first DCI format, decoding the DCI based on the first size, and where the DCI is of the second DCI format, decoding the DCI based on the second size.
In Aspect 3, the method of Aspect 2 includes where the DCI is of the first DCI format, the frequency resource switching table corresponds to a first frequency resource switching table having rows indicating, for each of multiple possible frequency resources, a single frequency resource of the multiple configured uplink frequency resources for switching, or where the DCI is of the second DCI format, the frequency resource switching table corresponds to a second frequency resource switching table having rows indicating, for each of multiple possible frequency resources, two frequency resources of the multiple configured uplink frequency resources for switching.
In Aspect 4, the method of any of Aspects 2 or 3 includes where the first size is associated with a maximum DCI size configured for one of the multiple configured uplink frequency resources, and the second size is associated with a maximum sum of DCI sizes configured for two of the multiple configured uplink frequency resources.
In Aspect 5, the method of any of Aspects 2 to 4 includes where decoding the DCI based on the first size includes obtaining a value of a field from the DCI configured for the single frequency resource, or where decoding the DCI based on the second size includes obtaining values of a field from the DCI configured for the two uplink frequency resources.
In Aspect 6, the method of any of Aspects 1 to 5 includes where the at least two DCI formats include a first DCI format having a first size and associated with switching to at least one of the multiple configured uplink frequency resources, and a second DCI format having a second size, larger than the first size, and associated with switching to at least another one of the multiple configured uplink frequency resources, where the DCI is of the first DCI format, decoding the DCI based on the first size, and where the DCI is of the second DCI format, decoding the DCI based on the second size.
In Aspect 7, the method of any of Aspects 1 to 6 includes decoding a second DCI received in the control channel search space based on another one of the at least two DCI formats and according to a second size associated with the another one of the at least two DCI formats, including decoding a second field from the second DCI, where switching to the one or more uplink frequency resources includes switching to concurrently transmit over the one or more uplink frequency resources and another one of the one or more uplink frequency resources indicated in the frequency resource switching table or another frequency resource switching table based on the second field.
In Aspect 8, the method of Aspect 7 includes where the size is associated with a maximum DCI size configured for the at least one of the multiple configured uplink frequency resources, and the second size is associated with a maximum DCI size configured for the another one of the multiple configured uplink frequency resources.
In Aspect 9, the method of any of Aspects 7 or 8 includes where decoding the DCI based on the size includes obtaining a first value of a field from the DCI for the at least one of the multiple configured uplink frequency resources, and where decoding the DCI based on the second size includes obtaining a second value of the field from the DCI for the another one of the multiple configured uplink frequency resources.
Aspect 10 is a method for wireless communication at a network node including encoding, for a UE, DCI based on one of at least two DCI formats associated with switching to one or more uplink frequency resources of multiple configured uplink frequency resources, where encoding the DCI is according to a size associated with the one of the at least two DCI formats, and includes encoding a field in the DCI, transmitting the DCI in a control channel search space, and switching to one or more uplink frequency resources indicated in a frequency resource switching table based on the field for receiving uplink transmissions from the UE.
In Aspect 11, the method of Aspect 10 includes where the at least two DCI formats include a first DCI format having a first size and associated with switching to a single frequency resource of the multiple configured uplink frequency resources, and a second DCI format having a second size, larger than the first size, and associated with switching to concurrently transmit over two uplink frequency resources of the multiple configured uplink frequency resources, where the DCI is of the first DCI format, encoding the DCI based on the first size, and where the DCI is of the second DCI format, encoding the DCI based on the second size.
In Aspect 12, the method of Aspect 11 includes where the DCI is of the first DCI format, the frequency resource switching table corresponds to a first frequency resource switching table having rows indicating, for each of multiple possible frequency resources, a single frequency resource of the multiple configured uplink frequency resources for switching, or where the DCI is of the second DCI format, the frequency resource switching table corresponds to a second frequency resource switching table having rows indicating, for each of multiple possible frequency resources, two frequency resources of the multiple configured uplink frequency resources for switching.
In Aspect 13, the method of any of Aspects 11 or 12 includes where the first size is associated with a maximum DCI size configured for one of the multiple configured uplink frequency resources, and the second size is associated with a maximum sum of DCI sizes configured for two of the multiple configured uplink frequency resources.
In Aspect 14, the method of any of Aspects 11 to 13 includes where encoding the DCI based on the first size includes encoding a value of a field in the DCI configured for the single frequency resource, or where encoding the DCI based on the second size includes encoding values of a field in the DCI configured for the two uplink frequency resources.
In Aspect 15, the method of any of Aspects 10 to 14 includes where the at least two DCI formats include a first DCI format having a first size and associated with switching to at least one of the multiple configured uplink frequency resources, and a second DCI format having a second size, larger than the first size, and associated with switching to at least another one of the multiple configured uplink frequency resources, where the DCI is of the first DCI format, encoding the DCI based on the first size, and where the DCI is of the second DCI format, encoding the DCI based on the second size.
In Aspect 16, the method of any of Aspects 10 to 15 includes encoding a second DCI based on another one of the at least two DCI formats and according to a second size associated with the another one of the at least two DCI formats, including encoding a second field in the second DCI, and transmitting the second DCI in a control channel search space, where switching to the one or more uplink frequency resources includes switching to concurrently receive uplink transmissions from the UE over the one or more uplink frequency resources and another one of the one or more uplink frequency resources indicated in the frequency resource switching table or another frequency resource switching table based on the second field.
In Aspect 17, the method of Aspect 16 includes where the size is associated with a maximum DCI size configured for the at least one of the multiple configured uplink frequency resources, and the second size is associated with a maximum DCI size configured for the another one of the multiple configured uplink frequency resources.
In Aspect 18, the method of any of Aspects 16 or 17 includes where encoding the DCI based on the size includes encoding a first value of a field in the DCI configured for the at least one of the multiple configured uplink frequency resources, and where encoding the DCI based on the second size includes encoding a second value of the field in the DCI configured for the another one of the multiple configured uplink frequency resources.
Aspect 19 is an apparatus for wireless communication including one or more memories configured to store instructions, and one or more processors communicatively coupled with the one or more memories, where the one or more processors are configured to execute the instructions to cause the apparatus to perform any of the methods of Aspects 1 to 18.
Aspect 20 is an apparatus for wireless communication including means for performing any of the methods of Aspects 1 to 18.
Aspect 21 is one or more computer-readable media including code executable by one or more processors for wireless communications, the code including code for performing any of the methods of Aspects 1 to 18.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
monitor a control channel search space for downlink control information (DCI) based on at least two DCI formats associated with switching to one or more uplink frequency resources of multiple configured uplink frequency resources;
decode the DCI received in the control channel search space based on one of the at least two DCI formats and according to a size associated with the one of the at least two DCI formats, including decoding a field from the DCI; and
switch to the one or more uplink frequency resources indicated in a frequency resource switching table based on the field.

2. The apparatus of claim 1, wherein the at least two DCI formats include:
a first DCI format having a first size and associated with switching to a single frequency resource of the multiple configured uplink frequency resources; and
a second DCI format having a second size, larger than the first size, and associated with switching to concurrently transmit over two uplink frequency resources of the multiple configured uplink frequency resources;
where the DCI is of the first DCI format, the one or more processors are, individually or in combination, configured to execute the instructions to cause the apparatus to decode the DCI based on the first size; and
where the DCI is of the second DCI format, the one or more processors are, individually or in combination, configured to execute the instructions to cause the apparatus to decode the DCI based on the second size.

3. The apparatus of claim 2, wherein:
where the DCI is of the first DCI format, the frequency resource switching table corresponds to a first frequency resource switching table having rows indicating, for each of multiple possible frequency resources, a single frequency resource of the multiple configured uplink frequency resources for switching, or
where the DCI is of the second DCI format, the frequency resource switching table corresponds to a second frequency resource switching table having rows indicating, for each of multiple possible frequency resources, two frequency resources of the multiple configured uplink frequency resources for switching.

4. The apparatus of claim 2, wherein the first size is associated with a maximum DCI size configured for one of the multiple configured uplink frequency resources, and the second size is associated with a maximum sum of DCI sizes configured for two of the multiple configured uplink frequency resources.

5. The apparatus of claim 2, wherein the one or more processors are, individually or in combination, configured to execute the instructions to cause the apparatus to decode the DCI based on the first size including obtaining a value of a field from the DCI configured for the single frequency resource, or wherein the one or more processors are, individually or in combination, configured to execute the instructions to cause the apparatus to decode the DCI based on the second size including obtaining values of a field from the DCI configured for the two uplink frequency resources.

6. The apparatus of claim 1, wherein the at least two DCI formats include:
a first DCI format having a first size and associated with switching to at least one of the multiple configured uplink frequency resources; and
a second DCI format having a second size, larger than the first size, and associated with switching to at least another one of the multiple configured uplink frequency resources;
where the DCI is of the first DCI format, the one or more processors are, individually or in combination, configured to execute the instructions to cause the apparatus to decode the DCI based on the first size; and
where the DCI is of the second DCI format, the one or more processors are, individually or in combination, configured to execute the instructions to cause the apparatus to decode the DCI based on the second size.

7. The apparatus of claim 1, wherein the one or more processors are, individually or in combination, configured to execute the instructions to cause the apparatus to decode a second DCI received in the control channel search space based on another one of the at least two DCI formats and according to a second size associated with the another one of the at least two DCI formats, including decoding a second field from the second DCI, wherein the one or more processors are, individually or in combination, configured to execute the instructions to cause the apparatus to switch to the one or more uplink frequency resources including switching to concurrently transmit over the one or more uplink frequency resources and another one of the one or more uplink frequency resources indicated in the frequency resource switching table or another frequency resource switching table based on the second field.

8. The apparatus of claim 7, wherein the size is associated with a maximum DCI size configured for the at least one of the multiple configured uplink frequency resources, and the second size is associated with a maximum DCI size configured for the another one of the multiple configured uplink frequency resources.

9. The apparatus of claim 7, wherein the one or more processors are, individually or in combination, configured to execute the instructions to cause the apparatus to decode the DCI based on the size including obtaining a first value of a field from the DCI for the at least one of the multiple configured uplink frequency resources, and wherein the one or more processors are, individually or in combination, configured to execute the instructions to cause the apparatus to decode the DCI based on the second size including obtaining a second value of the field from the DCI for the another one of the multiple configured uplink frequency resources.

10. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
encode, for a user equipment (UE), downlink control information (DCI) based on one of at least two DCI formats associated with switching to one or more uplink frequency resources of multiple configured uplink frequency resources, wherein the one or more processors are, individually or in combination, configured to execute the instructions to cause the apparatus to encode the DCI according to a size associated with the one of the at least two DCI formats, and includes encoding a field in the DCI;
transmit the DCI in a control channel search space; and
switch to one or more uplink frequency resources indicated in a frequency resource switching table based on the field for receiving uplink transmissions from the UE.

11. The apparatus of claim 10, wherein the at least two DCI formats include:
a first DCI format having a first size and associated with switching to a single frequency resource of the multiple configured uplink frequency resources; and
a second DCI format having a second size, larger than the first size, and associated with switching to concurrently transmit over two uplink frequency resources of the multiple configured uplink frequency resources;
where the DCI is of the first DCI format, the one or more processors are, individually or in combination, configured to execute the instructions to cause the apparatus to encode the DCI based on the first size; and
where the DCI is of the second DCI format, the one or more processors are, individually or in combination, configured to execute the instructions to cause the apparatus to encode the DCI based on the second size.

12. The apparatus of claim 11, wherein:
where the DCI is of the first DCI format, the frequency resource switching table corresponds to a first frequency resource switching table having rows indicating, for each of multiple possible frequency resources, a single frequency resource of the multiple configured uplink frequency resources for switching, or
where the DCI is of the second DCI format, the frequency resource switching table corresponds to a second frequency resource switching table having rows indicating, for each of multiple possible frequency resources, two frequency resources of the multiple configured uplink frequency resources for switching.

13. The apparatus of claim 11, wherein the first size is associated with a maximum DCI size configured for one of the multiple configured uplink frequency resources, and the second size is associated with a maximum sum of DCI sizes configured for two of the multiple configured uplink frequency resources.

14. The apparatus of claim 11, wherein the one or more processors are, individually or in combination, configured to execute the instructions to cause the apparatus to encode the DCI based on the first size including encoding a value of a field in the DCI configured for the single frequency resource, or wherein the one or more processors are, individually or in combination, configured to execute the instructions to cause the apparatus to encode the DCI based on the second size including encoding values of a field in the DCI configured for the two uplink frequency resources.

15. The apparatus of claim 10, wherein the at least two DCI formats include:
a first DCI format having a first size and associated with switching to at least one of the multiple configured uplink frequency resources; and
a second DCI format having a second size, larger than the first size, and associated with switching to at least another one of the multiple configured uplink frequency resources;
where the DCI is of the first DCI format, the one or more processors are, individually or in combination, configured to execute the instructions to cause the apparatus to encode the DCI based on the first size; and
where the DCI is of the second DCI format, the one or more processors are, individually or in combination, configured to execute the instructions to cause the apparatus to encode the DCI based on the second size.

16. The apparatus of claim 10, wherein the one or more processors are, individually or in combination, configured to execute the instructions to cause the apparatus to encode a second DCI based on another one of the at least two DCI formats and according to a second size associated with the another one of the at least two DCI formats, including encoding a second field in the second DCI; and
transmit the second DCI in a control channel search space,
wherein the one or more processors are, individually or in combination, configured to execute the instructions to cause the apparatus to switch to the one or more uplink frequency resources including switching to concurrently receive uplink transmissions from the UE over the one or more uplink frequency resources and another one of the one or more uplink frequency resources indicated in the frequency resource switching table or another frequency resource switching table based on the second field.

17. The apparatus of claim 16, wherein the size is associated with a maximum DCI size configured for the at least one of the multiple configured uplink frequency resources, and the second size is associated with a maximum DCI size configured for the another one of the multiple configured uplink frequency resources.

18. The apparatus of claim 16, wherein the one or more processors are, individually or in combination, configured to execute the instructions to cause the apparatus to encoding the DCI based on the size including encoding a first value of a field in the DCI configured for the at least one of the multiple configured uplink frequency resources, and wherein the one or more processors are, individually or in combination, configured to execute the instructions to cause the apparatus to encoding the DCI based on the second size including encoding a second value of the field in the DCI configured for the another one of the multiple configured uplink frequency resources.

19. A method for wireless communication at a user equipment (UE), comprising:
monitoring a control channel search space for downlink control information (DCI) based on at least two DCI formats associated with switching to one or more uplink frequency resources of multiple configured uplink frequency resources;
decoding the DCI received in the control channel search space based on one of the at least two DCI formats and according to a size associated with the one of the at least two DCI formats, including decoding a field from the DCI; and
switching to the one or more uplink frequency resources indicated in a frequency resource switching table based on the field.

20. The method of claim 19, wherein the at least two DCI formats include:
a first DCI format having a first size and associated with switching to a single frequency resource of the multiple configured uplink frequency resources; and
a second DCI format having a second size, larger than the first size, and associated with switching to concurrently transmit over two uplink frequency resources of the multiple configured uplink frequency resources;
where the DCI is of the first DCI format, decoding the DCI based on the first size; and
where the DCI is of the second DCI format, decoding the DCI based on the second size.

21. The method of claim 20, wherein:
where the DCI is of the first DCI format, the frequency resource switching table corresponds to a first frequency resource switching table having rows indicating, for each of multiple possible frequency resources, a single frequency resource of the multiple configured uplink frequency resources for switching, or
where the DCI is of the second DCI format, the frequency resource switching table corresponds to a second frequency resource switching table having rows indicating, for each of multiple possible frequency resources, two frequency resources of the multiple configured uplink frequency resources for switching.

22. The method of claim 20, wherein the first size is associated with a maximum DCI size configured for one of the multiple configured uplink frequency resources, and the second size is associated with a maximum sum of DCI sizes configured for two of the multiple configured uplink frequency resources.

23. The method of claim 20, wherein decoding the DCI based on the first size includes obtaining a value of a field from the DCI configured for the single frequency resource, or wherein decoding the DCI based on the second size includes obtaining values of a field from the DCI configured for the two uplink frequency resources.

24. The method of claim 19, wherein the at least two DCI formats include:
a first DCI format having a first size and associated with switching to at least one of the multiple configured uplink frequency resources; and
a second DCI format having a second size, larger than the first size, and associated with switching to at least another one of the multiple configured uplink frequency resources;
where the DCI is of the first DCI format, decoding the DCI based on the first size; and
where the DCI is of the second DCI format, decoding the DCI based on the second size.

25. The method of claim 19, further comprising decoding a second DCI received in the control channel search space based on another one of the at least two DCI formats and according to a second size associated with the another one of the at least two DCI formats, including decoding a second field from the second DCI, wherein switching to the one or more uplink frequency resources includes switching to concurrently transmit over the one or more uplink frequency resources and another one of the one or more uplink frequency resources indicated in the frequency resource switching table or another frequency resource switching table based on the second field.

26. The method of claim 25, wherein the size is associated with a maximum DCI size configured for the at least one of the multiple configured uplink frequency resources, and the second size is associated with a maximum DCI size configured for the another one of the multiple configured uplink frequency resources.

27. The method of claim 25, wherein decoding the DCI based on the size includes obtaining a first value of a field from the DCI for the at least one of the multiple configured uplink frequency resources, and wherein decoding the DCI based on the second size includes obtaining a second value of the field from the DCI for the another one of the multiple configured uplink frequency resources.

28. A method for wireless communication at a network node, comprising:
encoding, for a user equipment (UE), downlink control information (DCI) based on one of at least two DCI formats associated with switching to one or more uplink frequency resources of multiple configured uplink frequency resources, wherein encoding the DCI is according to a size associated with the one of the at least two DCI formats, and includes encoding a field in the DCI;
transmitting the DCI in a control channel search space; and
switching to one or more uplink frequency resources indicated in a frequency resource switching table based on the field for receiving uplink transmissions from the UE.

29. The method of claim 28, wherein the at least two DCI formats include:
a first DCI format having a first size and associated with switching to a single frequency resource of the multiple configured uplink frequency resources; and
a second DCI format having a second size, larger than the first size, and associated with switching to concurrently transmit over two uplink frequency resources of the multiple configured uplink frequency resources;
where the DCI is of the first DCI format, encoding the DCI based on the first size; and
where the DCI is of the second DCI format, encoding the DCI based on the second size.

30. The method of claim 29, wherein:
where the DCI is of the first DCI format, the frequency resource switching table corresponds to a first frequency resource switching table having rows indicating, for each of multiple possible frequency resources, a single frequency resource of the multiple configured uplink frequency resources for switching, or
where the DCI is of the second DCI format, the frequency resource switching table corresponds to a second frequency resource switching table having rows indicating, for each of multiple possible frequency resources, two frequency resources of the multiple configured uplink frequency resources for switching.
